(19) United States
(12) Patent Application Publication
(10) Pub. No.: US 2007/0170687 A1
(43) Pub. Date: Jul. 26, 2007

(54) Push balls for propelling a wheelchair

(76) Inventors: Russell Bonjour, Colton, CA (US); Karen Fadri-Atil, Rancho Cucamonga, CA (US)

Correspondence Address: JAMES RAY & ASSOCIATES, 2640 PITCAIRN ROAD, MONROEVILLE, PA, 15146, US

(21) Appl. No.: 11/653,712

(22) Filed: Jan. 16, 2007

Related U.S. Application Data
(60) Provisional application No. 60/761,490, filed on Jan. 24, 2006.

(51) Int. Cl. B62M 1/14

(52) U.S. Cl. 280/250.1

(57) ABSTRACT

An apparatus for assisting a wheelchair user in turning the wheel in a manually propelled wheelchair. The apparatus comprises a plurality of ball shaped members, such plurality of ball shaped members being divided in substantially symmetrical halves. There is a groove disposed at a predetermined location on an inner surface of each half of the plurality of ball shaped members for engaging a hand rim of such wheelchair and a threaded means for securing each half of the plurality of ball shaped members to the other half of the plurality of ball shaped members.

### CROSS REFERENCE TO RELATED APPLICATIONS

This application is closely related to and claims benefit from U.S. Provisional Application Ser. No. 60/761,490 filed Jan. 24, 2006.

### FIELD OF THE INVENTION

The present invention relates, in general, to a wheelchair, and, more particularly, the present invention relates to a means for turning a wheelchair wheel that is easier than using the hand rim of the wheel and one that also provides an ergonomic surface for the hand of the user in turning the wheel.

### BACKGROUND OF THE INVENTION

Wheelchair push rims (hand rims) are normally used for a user to propel his/her wheelchair. By turning the hand rim the wheel of the wheelchair also turns thereby causing the wheelchair to move. Sometimes these hand rails can be very difficult to grab for use. This is particularly true if the rims are hot, wet or slick. When traveling alone in an outdoor environment these elemental inconveniences can cause a severe disruption of the wheelchair user's lifestyle.

Further, for an individual using the hand rim to propel the wheelchair can be very tiring on the hands and many wheelchair users are seen wearing gloves because turning the hand rim can not only be tiring but can also cause blisters or sores on the hands of the user from the constant gripping and pushing motion required to propel the wheelchair. This is particularly true since most wheelchair users are elderly and are more prone to getting tired easily and also whose skin tends to be more sensitive to abrasion.

Thus, it would be advantageous if there were a means available that would provide the wheelchair user with a way of propelling the wheelchair that is easier, less painful and tiring to the user particularly for those users who have little strength or have a weakened grip.

### SUMMARY OF THE INVENTION

In a first aspect the present invention provides an apparatus for assisting a wheelchair user in turning the wheel in a manually propelled wheelchair. The apparatus comprises a plurality of ball shaped members, such plurality of ball shaped members being divided in substantially symmetrical halves. There is a groove disposed at a predetermined location on an inner surface of each half of the plurality of ball shaped members for engaging a hand rim of such wheelchair and a means for securing each half of the plurality of ball shaped members to the other half of the plurality of ball shaped members.

### OBJECTS OF THE INVENTION

It is, therefore, one of the primary objects of the present invention is to provide an apparatus for assisting a wheelchair user to propel the wheelchair.

Another object of the present invention is to provide an apparatus for assisting a wheelchair user to propel the wheelchair that is easy to mount on the wheelchair.

Still another object of the present invention is to provide an apparatus for assisting a wheelchair user to propel the wheelchair that is simple to use.

Yet another object of the present invention is to provide an apparatus for assisting a wheelchair user to propel the wheelchair that is relatively inexpensive.

Another object of the present invention is to provide an apparatus for assisting a wheelchair user to propel the wheelchair that is comfortable to use and offers those with a weakened grip or little strength a better and easier way to move the wheelchair.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the binder of the apparatus used to mount on a hand rim of a wheelchair to assist in propelling the wheelchair.

FIG. 2 is a perspective view of the apparatus shown in FIG. 1 showing the two halves of the apparatus.

FIG. 3 is a perspective view of a wheelchair with the apparatus shown in FIGS. 1 and 2 mounted on several places on the hand rim of the wheelchair.

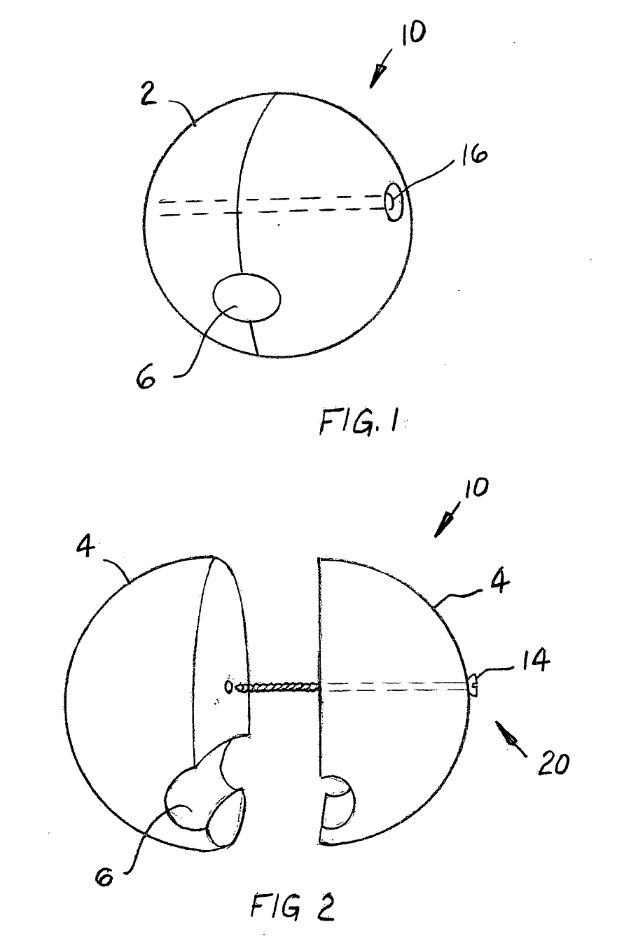

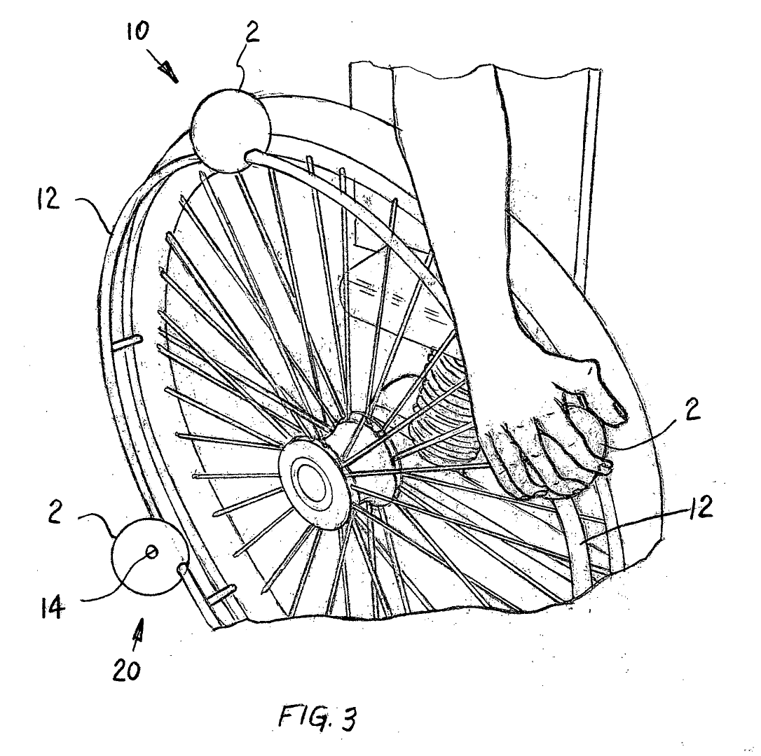

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for assisting a wheelchair user in turning the wheel in a manually propelled wheelchair. The apparatus 10 comprises a plurality of ball shaped members 2, such plurality of ball shaped members 2 being divided in substantially symmetrical halves 4. There is a groove 6 disposed at a predetermined location on an inner surface of each half 4 of the plurality of ball shaped members 2 for engaging a hand rim 12 of such wheelchair and a means, generally designated 20, for securing each half 4 of the plurality of ball shaped members 2 to the other half 4 of the plurality of ball shaped members 2.

Such means for securing each half 4 of the plurality of ball shaped members 2 to another half 4 of the plurality of ball shaped members 4 includes one of a threaded means and an adhesive. It is presently preferred that such means 20 is a threaded means and that such threaded means is a screw 14.

Such means for securing each half 4 of the plurality of ball shaped members 2 to another half 4 of the plurality of ball shaped members 4 further includes an aperture 16 that is disposed in one half 4 of the plurality of ball shaped members 2 in substantially a center of the one half 4 of said plurality of ball shaped members 4. The aperture 14 extends completely through the one half 4 of the plurality of ball shaped members 2 and extends from an inner surface of the other half 4 of the plurality of ball shaped members 2 approximately ⅔ of the way through the another half 4 of the plurality of ball shaped members 2.

Thus, the threaded means 20 (screw 14) engages the aperture 16 for securing the one half 4 of the plurality of ball shaped members 2 to the other half 4 of the plurality of ball shaped members 4 to form the ball shaped members.

The predetermined shape of the groove 6 that is disposed at a predetermined location on the inner surface on each half 4 of the plurality of ball shaped members 2 is arcuately shaped so as to conform to the curvature of such wheelchair hand rim 12. The predetermined location of the groove 6 is in a lower quadrant of each half 4 of the plurality of ball shaped members 2 so that when the ball shaped member 2 is secured to such hand rim 12 more than half of the ball shaped member 2 extends above such hand rim 12.

The predetermined material for forming the plurality of ball shaped members 2 is selected from one of plastic and rubber and it is presently preferred that such material is plastic. It is also presently preferred that such plurality of ball shaped members used to engage such hand rim 12 of a wheel chair is at least four.

Thus, the present invention provides a plurality of ball shaped members 2 that attach to the hand rim 12 of a wheelchair to assist the user in propelling the wheelchair. As stated previously propelling the wheelchair with the hand rim can be very tiring for many users and can also cause blisters on the hands. Many users wear gloves for this reason. The majority of wheelchair user are elderly and probably have a weak grip which makes the use of the hand rim 12 even that much more difficult. With the balls 2 attached at various points on the hand rim 12 the user now has something that is easier to grip and thus makes it easier to turn the wheel. By pushing on one ball 2 until the wheel has turned a sufficient distance a second ball 2 comes around and the user then just switches the second ball 2. The user pushes on this ball to turn the wheel and then a third ball 2 will come up and again the user just moves to the third ball and so on. The number of the balls that are mounted on the hand rim 12 will be determined by the user as to how far the wheel is pushed with each ball. For someone with long arms fewer balls are needed and conversely someone with shorter arms or less strength would probably require the use of more balls 2 to be mounted on the hand rims 12. It is preferred that at least four balls are used on the hand rims 12 of the wheelchair. In any case it is much easier to propel the wheel by using the balls 2 and thus the wheelchair than it is just using the hand rim 12. Further, since there is less strain on the fingers and hands using the balls 2 there is less strain on the user especially since gripping the balls is essentially an ergonomic grip. The balls 2 are mounted easily on the hand rim 12 with just a screwdriver. The two halves 4 are placed over the hand rim 12 and since the groove 6 follows the contour of the hand rim 12 they mount easily and then are secured with the screw 14 which passes through the aperture to the second half 4 and then tightened.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for assisting a wheelchair user in turning a wheel in a manually propelled wheelchair, said apparatus comprising:
(a) a plurality of ball shaped members being formed of a predetermined material, said plurality of ball shaped members being divided in substantially symmetrical halves;
(b) a groove disposed at a predetermined location on an inner surface of each half of said plurality of ball shaped members for engaging a hand rim of a wheelchair, said groove having a predetermined shape; and
(c) a means for securing said each half of said plurality of ball shaped members to another half of said plurality of ball shaped members.

2. The apparatus, according to claim 1, wherein said means for securing each half of said plurality of ball shaped members to another half of said plurality of ball shaped members includes one of a threaded means and an adhesive.

3. The apparatus, according to claim 1, wherein said means for securing each half of said plurality of ball shaped members to another half of said plurality of ball shaped members is a threaded means.

4. The apparatus, according to claim 3, wherein threaded means is a screw.

5. The apparatus, according to claim 3, wherein an aperture is disposed in one half of said plurality of ball shaped members in substantially a center of said one half of said plurality of ball shaped members, said aperture extends completely through said one half of said plurality of ball shaped members.

6. The apparatus, according to claim 5, wherein said aperture extends from an inner surface of another half of said plurality of ball shaped members approximately ⅔ of the way through said another half of said plurality of ball shaped members.

7. The apparatus, according to claim 6, wherein said threaded means engages said aperture for securing said one half of said plurality of ball shaped members to said another half of said plurality of ball shaped members to form said ball shaped members.

8. The apparatus, according to claim 1, wherein said predetermined shape of said groove disposed at predetermined location on said inner surface on said each half of said plurality of ball shaped members is arcuately shaped so as to conform to the curvature of such wheelchair hand rim.

9. The apparatus, according to claim 8, wherein said predetermined location of said groove is in a lower quadrant of said each half of said plurality of ball shaped members so that when said ball shaped member is secured to such hand rim more than half of said ball shaped member extends above such hand rim.10. The apparatus, according to claim 1, wherein said predetermined material for forming said plurality of ball shaped member is selected from one of plastic and rubber.

11. The apparatus, according to claim 10, wherein said predetermined material is plastic.

12. The apparatus, according to claim 1, wherein said plurality of said ball shaped members for engaging a hand rim of a wheel chair is at least four.
